(19) United States
(12) Patent Application Publication
(10) Pub. No.: US 2008/0214777 A1
(43) Pub. Date: Sep. 4, 2008

(54) Heteropolymeric Polyimide Polymer Compositions

(75) Inventor: Garrett D. Poe, Madison, AL (US)

Correspondence Address: BRADLEY ARANT ROSE & WHITE, LLP;INTELLECTUAL PROPERTY DEPARTMENT-NWJ, 1819 FIFTH AVENUE NORTH, BIRMINGHAM, AL, 35203-2104, US

(73) Assignee: SRS TECHNOLOGIES

(21) Appl. No.: 11/997,124

(22) PCT Filed: Aug. 1, 2006
(86) PCT No.: PCT/US06/29805

§ 371 Date: Jan. 28, 2008

Related U.S. Application Data
(60) Provisional application No. 60/705,151, filed on Aug. 2, 2005.

(51) Int. Cl. C08G 73/10

(52) U.S. Cl. 528/338; 528/347

(57) ABSTRACT

The present disclosure describes comprises a polyimide composition comprising at least one diamine monomer and at least two dianhydride monomer types, at least two diamine monomer types and at least one dianhydride monomer at least two diamine monomer types and at least two dianhydride monomer types. In one embodiment, the diamine monomers are 2,2-bis[4-(4aminophenoxy)phenyl]-hexafluoropropane (BDAF) or 4,4′-diaminobenzanilide (DABA) or combinations of the foregoing and the dianhydride monomers are 4,4′-(hexafluoroisopropylidene)di-phthalicanhydride (6-FDA) and 3,3′,4,4′-biphenyltetracarboxylic acid dianhydride (s-BDPA) or combinations of the foregoing. The polyimide compositions described herein have controllable and variable properties, such as but not limited to CTE, allowing the use of the polyimide compositions in a wide variety of applications.

This application claims priority to and the benefit of U.S. Provisional Application No. 60/705,151 filed Aug. 2, 2005.

### FIELD OF THE DISCLOSURE

The present disclosure relates to polyimide compositions. More particularly, the present invention relates to a polyimide composition that can be engineered to have a desired physical property.

### BACKGROUND

Polyimides are an important class of polymeric materials and are known for their superior performance characteristics. Most polyimides are comprised of relatively rigid molecular structures with aromatic/cyclic moieties and exhibit high glass transition temperatures, good mechanical strength, high Young's modulus, and excellent thermo-oxidative stability. Furthermore, the linearity and stiffness of the cyclic/aromatic backbone reduce segmental rotation and allow for molecular ordering which results in lower coefficients of thermal expansion (CTE) than those thermoplastic polymers having more flexible chains. In addition, the intermolecular associations of polyimide chains provide resistance to most solvents.

Polyimides may be synthesized by several methods. In the traditional two-step method of synthesizing aromatic polyimides, a solution of the aromatic diamine in a polar aprotic solvent, such as N-methylpyrrolidone (NMP), is prepared. To this solution a tetracarboxylic acid, usually in the form of a dianhydride, is added. The diamine and the tetracarboxylic acid are generally added in a 1:1 molar stoichiometry. The resulting polycondensation reaction forms a polyamic acid. The high molecular weight polyamic acid produced is soluble in the reaction solvent and, thus, the solution may be cast into a film on a suitable substrate, such as by spin casting. The cast film is heated in stages to elevated temperatures to remove solvent and convert the amic acid functional groups to imides with a cyclodehydration reaction, also called imidization. Alternatively, some polyamic acids may be converted in solution to soluble polyimides by using a chemical dehydrating agent, catalyst, and/or heat.

As a result of their favorable characteristics, polyimides have become widely used in the aerospace industry, the electronics industry and the telecommunications industry. However, polyimide polymers generally have higher CTE values than the substrates to which they are applied, such as, but not limited to, silicon, metals, ceramics, and glasses.

In the electronics industry, polyimides are used in applications such as forming protective and stress buffer coatings for semiconductors, dielectric layers for multilayer integrated circuits and multi-chip modules, high temperature solder masks, bonding layers for multilayer circuits, final passivating coatings on electronic devices, and the like. In addition, polyimides may form dielectric films in electrical and electronic devices such as motors, capacitors, semiconductors, printed circuit boards and other packaging structures.

The increased complexity of the applications for polyimides has created a demand to tailor the properties of such polyimides for specific applications. For example, microelectronic devices often consist of multilayer structures with alternating layers of conductors, such as metals or semiconductors, isolated by layers of dielectric insulators, such as polyimides. In order to manufacture such devices, multiple high temperature heating and cooling cycles are required. As a result, the conductors and the dielectric insulators experience multiple cycles of heating and cooling, often covering temperature ranges of 300 degrees Celsius or more. The heating and cooling cycles generates stresses as a result of differences in CTE values and other variables. These stresses may cause deformation, delamination and/or cracks which can degrade the performance of the device and/or lead to premature failure of the device. It is desirable to control the CTE of the polyimides so that the CTE value of the polyimide is matched as closely as possible to the CTE value of the substrate in the device in order to mitigate the thermal stresses.

Furthermore, in the aerospace industry, polyimide polymer films are used for optical applications as membrane reflectors and the like. In application, a polyimide membrane is secured by a metal (often aluminum, copper, or stainless steel) or composite (often graphite/epoxy or fiberglass) mounting ring that secures the polyimide film border. Such optical applications may be used in space, where the polyimide membrane and the mounting ring are subject to repeated and drastic heating and cooling cycles in orbit as the structure is exposed to alternating periods of sunlight and shade. If the CTE value for the polymer and the CTE value of the ring are not matched, the polyimide membrane reflector may not function optimally. By matching the CTE value of the polyimide membrane and the mounting ring, function can be improved.

Polyimide polymer films may also serve as an interlayer dielectric in both semiconductors and thin film multichip modules. The low dielectric constant, low stress, high modulus, and inherent ductility of polyimide films make them well suited for these multiple layer applications. Other uses for polyimides include alignment and/or dielectric layers for displays, and as a structural layer in micromachining applications.

The prior art has provided examples of polyimides with both high and low CTE values. The prior art has also taught methods to increase or decrease the CTE of a polyimide composition by varying the composition of “rigid” and “flexible” components of the polyimide composition. However, the prior art has not taught polyimide compositions as described herein that can be engineered to have a variety of properties, such as but not limited to CTE values, that match or substantially match the CTE values of the substrates to which they are applied. Such polyimide compositions would be useful in the art.

The present disclosure describes polyimide compositions where various properties, such as but not limited to CTE values, can be engineered based on the material to which the polyimide composition will be used. In one embodiment, the CTE value of the polyimide composition can be engineered to match or substantially match the CTE values of the substrate to which they are applied or the material with which they are used. In one embodiment, the polyimide composition comprise 4,4′-diaminobenzanilide (DABA), 2,2-bis[4-(4aminophenoxy)phenyl]-hexafluoropropane (BDAF) or combinations of DABA and BDAF as the diamine components and 3,3′,4,4′-biphenyltetracarboxylic acid dianhydride (s-BDPA), 4,4′-(hexafluoroisopropylidene)di-phthalicanhydride (6-FDA) or combinations of s-BDPA and 6-FDA.

### DETAILED DESCRIPTION

In its most general form, the present disclosure comprises a polyimide composition comprising a combination of diamine and tetracarboxcylic acid (such as but not limited to a dianhydride) components that are specifically engineered to have a desired property. The desired property may be selected from the group consisting of glass transition temperature, tensile strength, mechanical strength, Young's modulus, thermo-oxidative stability, CTE and combinations of the foregoing. The following discussion refers specifically to dianhydride components as the tetracarboxcylic acid components; however, it would be recognized by one or ordinary skill in the art that other tetracarboxcylic acids could be used with the teachings of the present disclosure.

In one embodiment, the polyimide composition comprises at least one diamine monomer and at least two dianhydride monomer types, said polyimide composition engineered to have a desired property by varying the molar ratio of the at least two dianhydride components with respect to one another. In an alternate embodiment, the polyimide composition comprises at least two diamine monomer types and at least one dianhydride monomer, said polyimide composition engineered to have a desired property by varying the molar ratio of the at least two diamine components with respect to one another. In yet another embodiment, the polyimide composition comprises at least two diamine monomer types and at least two dianhydride monomer types, said polyimide composition engineered to have a desired property by varying the molar ratio of the at least two dianhydride components with respect to one another, by varying the molar ratio of the at least two diamine components with respect to one another or by varying the molar ratio of the at least two dianhydride components with respect to one another and varying the molar ratio of the at least two diamine components with respect to one another.

Regardless of the number of diamine and dianhydride monomers types present, the total diamine and total dianhydride components are present in a molar ratio of approximately 1:1. As used herein the term “approximately” means within 10% of the values stated. However, ratios of total diamine to total dianhydride may be varied from approximately 0.9:1 to 1.1:1. Using ratios other than 1:1 results in a change in the chain length of the polyimide. Further, the chain length can be varied by adding a predetermined amount of a monoamine or a monofunctional anhydride (such a but not limited to a dicarboxcylic acid anhydride) to the reaction mixture. The monoamine or monofunctional anhydride dicarboxcylic anhydride may be variants of those described herein or those known in the art. In one embodiment, the dicarboxcylic anhydride is phthalic anhydride. In one embodiment, the monoamine and/or dicarboxcylic anhydride may be added in a molar excess of 1 to 5% or from 1 to 10%. However, in one embodiment, the reaction comprises no monoamine or dicarboxcylic anhydride components.

A polyimide homopolymer of a given diamine and a given dianhydride is useful for many applications in the art. However, for many applications, the physical properties of such polyimide composition will not be suitable. For example, consider a polyimide composition of DABA and s-BDPA. While this polyimide composition is useful for many applications in the art, for many applications, the CTE of the DABA and s-BDPA polyimide composition is too low and the modulus is too high. Therefore, in order to prepare polyimide compositions suitable for a wider variety of applications, additional diamine and/or dianhydride components may be added in order to produce a polyimide composition having a desired property (such as, but not limited to, CTE, modulus and/or tensile strength). In one embodiment, one or both of BDAF and 6-FDA may be added to provide to lower the rigidity of the polyimide composition.

The diamine and dianhydride components may be any diamine or dianhydride components that are known in the art. In one embodiment of the polyimide composition, the diamine monomers are BDAF, DABA or combinations of BDAF and DABA and the dianhydride monomers are 6-FDA, s-BDPA or combinations of 6-FDA and s-BDPA. In a further embodiment of the polyimide composition, the diamine component is DABA and the dianhydride component is s-BDPA, 6-FDA or both s-BDPA and 6-FDA. In yet another embodiment of the polyimide composition, the diamine component is DABA and BDAF and the dianhydride component is s-BDPA, 6-FDA or both s-BDPA and 6-FDA. In still a further embodiment of the polyimide composition, the diamine component is BDAF and the dianhydride component is s-BDPA, 6-FDA or both s-BDPA and 6-FDA. Exemplary polyimide polymer compositions of the present disclosure are set forth in Table 1.

In one aspect of the disclosure, BDAF is present on a mole percentage basis of 0 to 50%, provided that when BDAF is present on a mole percentage basis at 0%, 6-FDA is present on a mole percentage basis of at least 1%, and 6-FDA is present on a mole percentage basis of 0 to 50%, provided that when 6-FDA is present on a mole percentage basis at 0%, BDAF is present on a mole percentage basis of at least 1%. As stated above, regardless of the composition of the polyimide polymer composition, the ratio of diamine to dianhydride is approximately 1:1 or approximately 0.9:1 to 1.1:1.

The polyimide polymer compositions described herein have controllable physical properties (such as, but not limited to, CTE, modulus and/or tensile strength) based on the engineering discussed above. Exemplary polyimide compositions of the present disclosure are set forth in Table 1, along with their CTE values (expressed as parts per million per Kelvin, ppm/K), and Table 2, along with their initial Young's modulus (expressed thousands of pounds per square inch, KSI) and tensile strength (also expressed in KSI). In addition, Table 3 shows exemplary polyimide compositions comprising a monofunctional anhydride along with their CTE values. Lowering the rigidity of a polyimide composition generally results in a higher CTE and a lower modulus.

As can be seen from Table 1, the CTE value can be controlled by varying the composition of the diamine and dianhydride monomer components. Table 1 shows a range of CTE values determined at 25 to 200 degrees C. ranging from −16.5 ppm/K to 31.8 ppm/K and CTE values determined at −75 to 25 degrees C. ranging from −11.1 ppm/K to 24.1 ppm/K. With reference to samples 1-4 of Table 1, increasing the mole percentage of BDAF in a polyimide composition comprising DABA (89 to 50 mole %) and s-BPDA as the dianhydride (100 mole %) resulted in an increase in the CTE value (determined at 25 to 200 degrees C.) of the polyimide composition from −15.1 ppm/K (11 mole % BDAF) to 26.6 ppm/K (50 mole % BDAF). With reference to samples 5 and 10, increasing the mole percentage of 6-FDA in a polyimide composition comprising DABA (100 mole %) and s-BPDA (89 and 55 mole %) resulted in an increase in the CTE value (determined at 25 to 200 degrees C.) of the polyimide composition from −16.5 ppm/K (11 mole % 6-FDA) to 12.3 ppm/K (45 mole % 6-FDA). With reference to samples 6, 8 and 9, increasing the mole percentage of 6-FDA in a polyimide composition comprising DABA (67 mole %), BDAF (33 mole %) and s-BPDA (11 to 33 mole %) resulted in an increase in the CTE value (determined at 25 to 200 degrees C.) of the polyimide composition from 15.6 ppm/K (11 mole % 6-FDA) to 31.8 ppm/K (33 mole % 6-FDA). Finally, with reference to samples 5 and 6, increasing the mole percentage of BDAF in a polyimide composition comprising DABA (100 and 67 mole %), s-BPDA (89 mole %) and 6-FDA (89 mole %) resulted in an increase in the CTE value (determined at 25 to 200 degrees C.) of the polyimide composition from −16.5 ppm/K (0 mole % BDAF) to 15.6 ppm/K (33 mole % 6-FDA).

Table 2 shows that the initial modulus and tensile strength of the polyimide composition can be controlled by varying the composition of the diamine and dianhydride monomer components. Table 2 shows a range of initial Young's modulus values from 1006 KSI to 474 KSI and a range of tensile strength values from 32 KSI to 17 KSI. With reference to samples 6, 10 and 14 of Table 2, increasing the mole percentage of BDAF in a polyimide composition comprising DABA (89 to 50 mole %) and s-BPDA as the dianhydride (100 mole %) resulted in a decrease in the initial Young's modulus values of the polyimide composition from 889 KSI (11 mole % BDAF) to 549 KSI (33 mole % BDAF) and a decrease in the tensile strength values of the polyimide composition from 29 KSI (11 mole % BDAF) to 22 KSI (33 mole % BDAF). As can be seen in Table 1, the CTE values increased in these compositions. With reference to samples 1-5 of Table 2, increasing the mole percentage of 6-FDA in a polyimide composition comprising DABA (100 mole %) and s-BPDA as the dianhydride (78 to 50 mole %) resulted in a decrease in the initial Young's modulus values of the polyimide composition from 1006 KSI (78 mole % s-BDPA, 22 mole % 6-FDA) to 662 KSI (50 mole % s-BDPA and 6-FDA) and a decrease in the tensile strength values of the polyimide composition from 32 KSI (78 mole % s-BDPA, 22 mole % 6-FDA) to 24 (50 mole % s-BDPA and 6-FDA). Again, as can be seen in Table 1, the CTE values increased in these compositions.

Table 3 further shows the CTE value of the polyimide composition can be controlled by varying the composition of the diamine and dianhydride monomer components with the addition of a monofunctional anhydride (in this embodiment phthalic anhydride). Table 3 shows a range of CTE values determined at 25 to 200 degrees C. ranging from −15.0 ppm/K to 10.7 ppm/K and determined at −75 to 25 degrees C. ranging from −13.7 ppm/K to 6.7 ppm/K. With reference to samples 1-3 of Table 3, increasing the mole percentage of 6-FDA in a polyimide composition comprising DABA (100 mole %) as the diamine, s-BPDA (100 to 70 mole %) and phthalic anhydride as the monofuncitonal anhydride (at a 3% molar excess over the diamine component) resulted in an increase in the CTE value (determined at 25 to 200 degrees C.) of the polyimide composition from −15.0 ppm/K (0 mole % 6-FDA) to 10.7 ppm/K (30 mole % 6-FDA). The same general trend (increase in CTE values) was observed in the polyimide compositions shown in Table 1.

By providing a number of polyimide compositions having varying physical properties, such as, but not limited to, CTE, modulus and/or tensile strength, but otherwise having similar chemical composition and physical properties, the physical properties of the polyimide composition and the physical properties of the material with which the polyimide composition is used can be substantially matched. As used herein, the term “substantially matched” means the property of the polyimide composition and the property of the material with which the polyimide composition is used vary by less than 20%, less than 15%, less than 10%, less than 5%, less than 2% or less than 1%.

In one embodiment, the material is a substrate to which the polyimide composition is applied. In an alternate embodiment, the material is a material (such as, but not limited to a metal) to which the polyimide composition is attached. For example, assume the property of interest is the CTE. As the material/polyimide article is heated during the curing process or as a consequence of use, providing a polyimide polymer with a CTE value substantially matched to the CTE value of the material reduces the possibility of deformation, delamination and cracking.

The present disclosure also provides a method of engineering a polyimide composition to substantially match a selected property of a material with which the polyimide composition will be used. The property can be any property mentioned herein, such as, but not limited to, CTE, modulus and/or tensile strength. The method comprises (i) the steps of selecting a material with which the polyimide composition is to be used; (ii) determining the value of the property for the material; and (iii) engineering a polyimide composition to have a value for said property that substantially matches the value of the property from the material. In one embodiment, the property is a physical property. Suitable properties include any property mentioned herein, such as, but not limited to, CTE, modulus and/or tensile strength. In one embodiment, the material is a substrate to which the polyimide composition is applied. In an alternate embodiment, the material is a material (such as, but not limited to a metal) to which the polyimide composition is attached.

In one embodiment, the polyimide composition can be engineered using the methods described herein. For example, the polyimide composition may be engineered to comprise a combination of diamine and dianhydride components that are specifically engineered to have a desired property, such as, but not limited to, CTE, modulus and/or tensile strength. In one embodiment, the polyimide composition comprises at least one diamine monomer and at least two dianhydride monomer types, said polyimide composition engineered to have a desired property by varying the molar ratio of the at least two dianhydride components with respect to one another. In an alternate embodiment, the polyimide composition comprises at least two diamine monomer types and at least one dianhydride monomer, said polyimide composition engineered to have a desired property by varying the molar ratio of the at least two diamine components with respect to one another. In yet another embodiment, the polyimide composition comprises at least two diamine monomer types and at least two dianhydride monomer types, said polyimide composition engineered to have a desired property by varying the molar ratio of the at least two dianhydride components with respect to one another, by varying the molar ratio of the at least two diamine components with respect to one another or by varying the molar ratio of the at least two dianhydride components with respect to one another and varying the molar ratio of the at least two diamine components with respect to one another.

The diamine and dianhydride components may be any diamine or dianhydride components that are known in the art. In one embodiment of the polyimide composition, the diamine monomers are BDAF, DABA or combinations of BDAF and DABA and the dianhydride monomers are 6-FDA, s-BDPA or combinations of 6-FDA and s-BDPA.

The polyimide compositions may be prepared as is generally known in the art (for example, see U.S. Pat. Nos. 3,179,630 and 3,179,634, “Polyimides-Thermally Stable Polymers”, Plenum Publishing (1987), “Synthesis and Characterization of Thermosetting polyimide Oligomers for Microelectronics Packaging, Dunson D. L., (Dissertation submitted to faculty of the Virginia Polytechnic Institute and State University, Apr. 21, 2000).

In one embodiment of preparing the polyimide compositions of the present disclosure, the diamine component(s) is dissolved in a suitable solvent and the dianhydride component(s) is added to the solution. The resulting solution is agitated under controlled temperature conditions until polymerization of the diamine and dianhydride components is completed. The result is a solution of polyamic acid, the polyimide precursor. The amount of solvent used can be controlled so that the resulting polyimide precursor solutions are viscous enough to be fabricated into films by conventional techniques.

In an alternate embodiment, the dianhydride component may be provided as a dry material in a suitable container and the diamine component(s) may be provided as a solution using a suitable solvent. Once prepared, the diamine solution is introduced in a controlled manner to the dianhydride components. The resulting solution is stirred until all the dianhydride component(s) are in solution. The process may be carried out to minimize the introduction of water into the reaction (which can interfere with the polycondensation reaction between the diamine and the dianhydride).

Once the polyamic acid precursor is formed, the precursor is applied to a substrate for casting into a film or for application to the substrate. The polyamic acid precursor solution may be diluted before application to the substrate using an appropriate solvent. The solvent may be the same or different than was used in the polycondensation reaction. The degree of dilution impacts the viscosity of the polyamic acid precursor solution, which impacts thickness of the final polyimide film. For example, when spin coating is used, solutions of the polyamic acid precursor may range from about 5 to about 60 percent by weight. The polyamic acid precursor solution may be, applied using a static or dynamic method. In static methods, the polyamic acid precursor is applied to a stationary substrate and spread across the surface by spinning the substrate. In dynamic methods, the polyamic acid precursor is applied to a rotating substrate. In the case of both static and dynamic methods, the spin speed of the substrate is sufficient to produce a final coating having a desired thickness. Alternatively, the polyamic acid can be applied the substrate by other methods, such as, but not limited to, dipping, brushing, casting with a bar, roller-coating, spray-coating, dip-coating, whirler-coating, cascade-coating, or curtain-coating.

The spin speed of the substrate may be determined preparing a spin-curve for the desired polyamic acid precursor solution. In one embodiment, the spin-curve is creating by preparing the polyamic acid precursor solution, applying the polyamic acid precursor solution to a substrate, curing the polyamic acid and measuring the resulting thickness of the polymer produced. The thickness is graphically plotted versus the spin speed. In this manner, the desired thickness of the polyimide composition can be achieved.

After application to the substrate, the polyamic acid precursor may be imidized using thermal or chemical means to convert the polyamic acid into the corresponding polyimide. Methods for curing polyamic acid are well known in the art. Methods for curing are described in “Synthesis and Characterization of Thermosetting polyimide Oligomers for Microelectronics Packaging” as referenced above. In one embodiment, the polyamic acid is heated in solution at a temperature of about 100 degrees to 300 degrees Celsius. If desired an accelerator may be used, such as, but not limited to, a tertiary amine. Once cured, the polyimide composition can be isolated from the reaction mixture.

The substrate may be any material desired for a particular application. The substrate is selected to withstand the parameters used for processing and application. Suitable carriers include, but are not limited to, plastics, metal, metal alloys, semi-metals, semiconductors, glass, ceramics, silicon oxide, silicon nitride, indium tin oxide, and other inorganic materials. Metals include, but are not limited to, such as aluminum, copper, gold, ruthenium, and the like. Semiconductors include, but are not limited to, silicon, germanium, and germanium aresenide. The substrate may be prepared before application, such as by cleaning, dehydration, and plasma etching, if desired.

A variety of solvents may be used in the methods for polyimide preparation. Suitable solvents include, but are not limited to, aprotic, polar organic solvents. Exemplary solvents include, but are not limited, dimethylsulfoxide, diethylsulfoxide, N,N-dimethylformamide, N,N-diethylformamide, N,N-dimethylacetamide, N,N-diethylacetamide, N-methyl-2-pyrrolidone, N-cyclohexyl-2-pyrrolidone, 1,3-dimethyl-2-imidazolidinone, diethyleneglycoldimethoxyether, o-dichlorobenzene, phenols, cresols, xylenol, catechol, butyrolactones, and hexamethylphosphoramide. In one embodiment the solvents are N,N-dimethylacetamide or N-methyl-2-pyrrolidone. Other suitable solvents may be used as is known in the art. The solvents described or known in the art may be used alone or in any combination as mixtures.

All patents, patent applications and publications referred to herein are incorporated by reference to the extent fully set forth herein. Reference to any of the above mentioned materials is not an acknowledgement that these materials would be recognized to teach or suggest or be regarded as relevant by those of ordinary skill in the art.

### EXAMPLES

The following examples provide an exemplary synthesis of selected embodiments of the polyimides disclosed in the present application. The methods of synthesis are provided as exemplary in nature only and is not meant to limit the synthesis to the methods described below. Alternate methods of synthesis and alternate components for the synthesis may be used as is known in the art and as described herein.

### Example 1

Example 1 describes the synthesis of a polyimide composition comprising 78 mole % s-BPDA and 22 mole % 6-FDA as the dianhydride components and 78 mole % DABA and 22 mole % BDAF as the diamine components. This polyimide composition is shown in row 7 of Table 1.

To a 500 mL three-neck round bottom flask equipped with an overhead stirrer, thermometer, and rubber septa were added 14.05 g s-BPDA and 5.98 g 6-FDA. The flask was sealed and purged with dry nitrogen for 1 hour with gentle agitation from the overhead stir shaft. To a separate 250 mL single-neck round bottom flask were added 10.75 g DABA, 6.92 g BDAF, and a magnetic stirbar. The flask was sealed and purged with dry nitrogen for 1 hour. 210 g anhydrous DMAc solvent was introduced with a double-tipped needle into the amines-containing flask and heated to 145 degrees Celsius over the course of 90 minutes with a dry nitrogen sparge and vigorous agitation. The hot amines solution was transferred to the dianhydrides-containing flask with an insulated double tip needle while applying slow stirring from the overhead stir shaft under a dry nitrogen blanket. The hot solution was cooled to ambient temperature as the anhydrides dissolved over the course of 8 hours, and the solution was allowed to react for an additional 16 hours. The resultant solution is approximately 25,000 cp in viscosity at 25 degrees Celsius. The resulting solution was thinned to 5,000 cp with additional anhydrous DMAc.

### Example 2

Example 2 describes the synthesis of a polyimide composition comprising 67 mole % s-BPDA and 33 mole % 6-FDA as the dianhydride components and 67 mole % DABA and 33 mole % BDAF as the diamine components. This polyimide composition is shown in row 9 of Table 1.

To a 500 mL three-neck round bottom flask equipped with an overhead stirrer, thermometer, and rubber septa were added 11.19 g s-BPDA and 8.32 g 6-FDA. The flask was sealed and purged with dry nitrogen for 1 hour with gentle agitation from the overhead stir shaft. To a separate 250 mL single-neck round bottom flask were added 8.56 g DABA and 9.62 g of BDAF and a magnetic stirbar. The flask was sealed and purged with dry nitrogen for 1 hour. 210 g anhydrous DMAc solvent was introduced with a double-tipped needle into the amine-containing flask and heated to 145 degrees Celsius over the course of 90 minutes with a dry nitrogen sparge and vigorous agitation. The hot amine solution was transferred to the dianhydrides-containing flask with an insulated double tip needle while applying slow stirring from the overhead stir shaft under a dry nitrogen blanket. The hot solution was cooled to ambient temperature as the anhydrides dissolved over the course of 8 hours, and the solution was allowed to react for an additional 16 hours. The resultant solution is approximately 40,000 cp in viscosity at 25 degrees Celsius. The resulting solution was thinned to 5,000 cp with additional anhydrous DMAc.

### Examples 3

Example 3 describes the synthesis of a polyimide composition comprising 89 mole % s-BPDA and 11 mole % 6-DA as the dianhydride components and mole % DABA and 33 mole % BDAF as the diamine components. This polyimide composition is shown in row 6 of Table 1.

To a 500 mL three-neck round bottom flask equipped with an overhead stirrer, thermometer, and rubber septa were added 15.64 g s-BPDA and 2.92 g 6-FDA. The flask was sealed and purged with dry nitrogen for 1 hour with gentle agitation from the overhead stir shaft. To a separate 250 mL single-neck round bottom flask were added 9.01 g DABA, 10.12 g BDAF, and a magnetic stirbar. The flask was sealed and purged with dry nitrogen for 1 hour. 210 g anhydrous DMAc solvent was introduced with a double-tipped needle into the amines-containing flask and heated to 145 degrees Celsius over the course of 90 minutes with a dry nitrogen sparge and vigorous agitation. The hot amines solution was transferred to the dianhydrides-containing flask with an insulated double tip needle while applying slow stirring from the overhead stir shaft under a dry nitrogen blanket. The hot solution was cooled to ambient temperature as the anhydrides dissolved over the course of 8 hours, and the solution was allowed to react for an additional 16 hours. The resultant solution is approximately 20,000 cp in viscosity at 25 degrees Celsius. The solution was thinned to 5,000 cp with additional anhydrous DMAc.

### Example 4

Example 4 describes the synthesis of a polyimide composition comprising 70 mole % s-BPDA and 30 mole % 6-FDA as the dianhydride components, 100 mole % DABA as the diamine component and a 3% molar excess of a monofunctional anhydride. This polyimide composition is shown in row 3 of Table 3.

To a 500 mL three-neck round bottom flask equipped with an overhead stirrer, thermometer, and rubber septa were added 17.66 g s-BPDA, 11.43 g 6-FDA and 0.81 g of phthalic anhydride (representing a 3% molar excess of the monofunctional anhydride). The flask was sealed and purged with dry nitrogen for 1 hour with gentle agitation from the overhead stir shaft. To a separate 250 mL single-neck round bottom flask were added 20.11 g DABA and a magnetic stirbar. The flask was sealed and purged with dry nitrogen for 1 hour. 200 g anhydrous DMAc solvent was introduced with a double-tipped needle into the amines-containing flask and heated to 145 degrees Celsius over the course of 90 minutes with a dry nitrogen sparge and vigorous agitation. The hot amines solution was transferred to the dianhydrides/phthalic anhydride-containing flask with an insulated double tip needle while applying slow stirring from the overhead stir shaft under a dry nitrogen blanket. The hot solution was cooled to ambient temperature as the anhydrides dissolved over the course of 8 hours, and the solution was allowed to react for an additional 16 hours. The resultant solution is approximately 20,000 cp in viscosity at 25 degrees Celsius. The solution was thinned to 5,000 cp with additional anhydrous DMAc.

### Example 5

Example 5 describes the synthesis of a polyimide composition comprising 100 mole % s-BPDA as the dianhydride component, 80 mole % DABA and 20 mole % BDAF as the diamine components and a 3% molar excess of a monofunctional anhydride. This polyimide composition is shown in row 4 of Table 3.

To a 500 mL three-neck round bottom flask equipped with an overhead stirrer, thermometer, and rubber septa were added 24.59 g s-BPDA and 0.79 g of phthalic anhydride (representing a 3% molar excess of the monofunctional anhydride). The flask was sealed and purged with dry nitrogen for 1 hour with gentle agitation from the overhead stir shaft. To a separate 250 mL single-neck round bottom flask were added 15.68 g DABA, 8.94 g BDAF and a magnetic stirbar. The flask was sealed and purged with dry nitrogen for 1 hour. 200 g anhydrous DMAc solvent was introduced with a double-tipped needle into the amines-containing flask and heated to 145 degrees Celsius over the course of 90 minutes with a dry nitrogen sparge and vigorous agitation. The hot amines solution was transferred to the dianhydrides/phthalic anhydride-containing flask with an insulated double tip needle while applying slow stirring from the overhead stir shaft under a dry nitrogen blanket. The hot solution was cooled to ambient temperature as the anhydrides dissolved over the course of 8 hours, and the solution was allowed to react for an additional 16 hours. The resultant solution is approximately 20,000 cp in viscosity at 25 degrees Celsius. The solution was thinned to 5,000 cp with additional anhydrous DMAc.

TABLE 1
Exemplary Polyimide Compositions and CTE Values Thereof

| | Diamines | | Dianhydrides | | | CTE Value | |
|---|---|---|---|---|---|---|---|
| | Mole Percent | Mole Percent | Mole Percent | Mole Percent | | −75 to +25 | +25 to +200 |
| Sample | DABA | BDAF | s-BPDA | 6-FDA | Sample | (ppm/K) | (ppm/K) |
| 1 | 89.0 | 11.0 | 100.0 | 0.0 | 1 | −11.1 | −15.1 |
| 2 | 78.0 | 22.0 | 100.0 | 0.0 | 2 | 6.5 | 7.5 |
| 3 | 60.0 | 40.0 | 100.0 | 0.0 | 3 | 12.2 | 17.1 |
| 4 | 50.0 | 50.0 | 100.0 | 0.0 | 4 | 24.1 | 26.6 |
| 5 | 100.0 | 0.0 | 89.0 | 11.0 | 5 | −11.5 | −16.5 |
| 6 | 67.0 | 33.0 | 89.0 | 11.0 | 6 | 14.7 | 15.6 |
| 7 | 78.0 | 22.0 | 78.0 | 22.0 | 7 | 13.2 | 17.0 |
| 8 | 67.0 | 33.0 | 78.0 | 22.0 | 8 | 15.2 | 24.3 |
| 9 | 67.0 | 33.0 | 67.0 | 33.0 | 9 | 21.2 | 31.8 |
| 10 | 100.0 | 0.0 | 55.0 | 45.0 | 10 | 8.9 | 12.3 |

TABLE 2
Exemplary Polyimide Compositions and Characteristics Thereof

| | Diamines | | Dianhydrides | | | Tensile Data | |
|---|---|---|---|---|---|---|---|
| | Mole Percent | Mole Percent | Mole Percent | Mole Percent | | Initial Young's | Tensile Strength |
| Sample | DABA | BDAF | s-BPDA | 6-FDA | Sample | Modulus (KSI) | (KSI) |
| 1 | 100 | 0 | 78 | 22 | 1 | 1006 | 32 |
| 2 | 100 | 0 | 67 | 33 | 2 | 907 | 30 |
| 3 | 100 | 0 | 60 | 40 | 3 | 750 | 27 |
| 4 | 100 | 0 | 55 | 45 | 4 | 744 | 24 |
| 5 | 100 | 0 | 50 | 50 | 5 | 662 | 24 |
| 6 | 89 | 11 | 100 | 0 | 6 | 889 | 29 |
| 7 | 89 | 11 | 89 | 11 | 7 | 659 | 24 |
| 8 | 89 | 11 | 78 | 22 | 8 | 734 | 26 |
| 9 | 89 | 11 | 67 | 33 | 9 | 779 | 23 |
| 10 | 78 | 22 | 100 | 0 | 10 | 724 | 28 |
| 11 | 78 | 22 | 89 | 11 | 11 | 631 | 24 |
| 12 | 78 | 22 | 78 | 22 | 12 | 599 | 24 |
| 13 | 78 | 22 | 67 | 33 | 13 | 610 | 22 |
| 14 | 67 | 33 | 100 | 0 | 14 | 549 | 22 |
| 15 | 67 | 33 | 89 | 11 | 15 | 579 | 24 |
| 16 | 67 | 33 | 78 | 22 | 16 | 557 | 21 |
| 17 | 67 | 33 | 67 | 33 | 17 | 514 | 19 |
| 18 | 60 | 40 | 100 | 0 | 18 | 625 | 18 |
| 19 | 50 | 50 | 100 | 0 | 19 | 474 | 17 |

TABLE 3
Exemplary Polyimide Compositions and CTE Values Thereof

| | | | | | Monofunctional | | | |
|---|---|---|---|---|---|---|---|---|
| | Diamines | | Dianhydrides | | Anhydride | | CTE Value | |
| | Mole Percent | Mole Percent | Mole Percent | Mole Percent | % Molar excess | | −75 to +25 | +25 to +200 |
| Sample | DABA | BDAF | s-BPDA | 6-FDA | phthalic anhydride | Sample | (ppm/K) | (ppm/K) |
| 1 | 100 | 0 | 100.0 | 0.0 | 3 | 1 | −13.7 | −15.0 |
| 2 | 100 | 0 | 80 | 20 | 3 | 2 | −2.8 | −1.7 |
| 3 | 100 | 0 | 70 | 30 | 3 | 3 | 6.7 | 10.7 |
| 4 | 80 | 20 | 100.0 | 0.0 | 3 | 4 | 2.1 | 2.4 |

What is claimed:

1. A polyimide composition comprising at least one diamine component and at least two dianhydride components, wherein a component of the at least one diamine component includes 4′-diaminobenzanilide (DABA) said polyimide composition engineered to have a desired property by varying the molar ratio of the at least two dianhydride components with respect to one another.

2. The composition of claim 1 where the desired property is selected from the group consisting of glass transition temperature, tensile strength, mechanical strength, Young's modulus, thermo-oxidative stability and coefficient of thermal expansion (CTE).

3. The composition of claim 1 where the desired property is CTE.

4. The composition of claim 1 where the diamine component is selected from the group consisting of DABA, 2,2-bis[4-(4aminophenoxy)phenyl]-hexafluoropropane (BDAF) and a combination of DABA and BDAF, and the dianhydride component is selected from the group consisting of 3,3′,4,4′-biphenyltetracarboxylic acid dianhydride (s-BDPA), 4,4′-(hexafluoroisopropylidene)di-phthalicanhydride (6-FDA) and a combination of s-BDPA and 6-FDA.

5. The composition of claim 1 where the total diamine and total dianhydride components are present in a ratio of approximately 1:1.

6. The composition of claim 1 further comprising a monoamine, a monofunctional anhydride or a combination of the foregoing.

7. A polyimide composition comprising at least two diamine components and at least one dianhydride components, wherein a component of the at least two diamine components includes 4′-diaminobenzanilide (DABA), said polyimide composition engineered to have a desired physical property by varying the molar ratio of the at least two diamine components with respect to one another.

8. The composition of claim 7 where the desired property is selected from the group consisting of glass transition temperature, tensile strength, mechanical strength, Young's modulus, thermo-oxidative stability and coefficient of thermal expansion (CTE).

9. The composition of claim 7 where the desired property is CTE.

10. The composition of claim 7 where the diamine component is selected from the group consisting of DABA, BDAF and a combination of DABA and BDAF and the dianhydride component is selected from the group consisting of s-BDPA, 6-FDA and a combination of s-BDPA and 6-FDA.

11. The composition of claim 7 where the total diamine and total dianhydride components are present in a ratio of approximately 1:1.

12. The composition of claim 7 further comprising a monoamine, a monofunctional anhydride or a combination of the foregoing.

13. A polyimide composition comprising at least two diamine components and at least two dianhydride components, wherein a component of the at least two diamine components includes 4′-diaminobenzanilide (DABA) said polyimide composition engineered to have a desired property by varying the molar ratio of the at least two dianhydride components with respect to one another, by varying the molar ratio of the at least two diamine components with respect to one another or by varying the molar ratio of the at least two dianhydride components with respect to one another and varying the molar ratio of the at least two diamine components with respect to one another.

14. The composition of claim 13 where the desired property is selected from the group consisting of glass transition temperature, tensile strength, mechanical strength, Young's modulus, thermo-oxidative stability and coefficient of thermal expansion (CTE).

15. The composition of claim 13 where the desired property is CTE.

16. The composition of claim 13 where the diamine component is a combination of DABA and BDAF and the dianhydride component is a combination of s-BDPA and 6-FDA.

17. The composition of claim 13 where the total diamine and total dianhydride components are present in a ratio of approximately 1:1.

18. The composition of claim 13 further comprising a monoamine, a monofunctional anhydride or a combination of the foregoing.

19. A method of engineering a polyimide composition to substantially match a selected property of a material with which the polyimide composition will be used, the polyimide composition comprising at least one diamine component and at least two dianhydride components, at least two diamine components and at least one dianhydride component or at least two diamine components and at least two dianhydride components, wherein the polyimide composition always contains a 4′-diaminobenzanilide (DABA) component, the method comprising the steps of:
a. selecting the material with which the polyimide composition will be used;
b. determining value of the property for said material; and
c. engineering a polyimide composition to have a value for the property that substantially matches the value of the property from the material, the engineering step being accomplished by varying the molar ratio of the at least two dianhydride components with respect to one another, by varying the molar ratio of the at least two diamine components with respect to one another or by varying the molar ratio of the at least two dianhydride components with respect to one another and varying the molar ratio of the at least two diamine components with respect to one another.

20. The method of claim 19 where the desired property is selected from the group consisting of glass transition temperature, tensile strength, mechanical strength, Young's modulus, thermo-oxidative stability and coefficient of thermal expansion (CTE).

21. The method of claim 19 where the material is a substrate to which the polyimide composition will be applied.

22. The method of claim 19 where the material is a material with which the polyimide composition will be used.

23. The method of claim 19 where said polyimide composition comprises at least one diamine component and at least two dianhydride components, and said engineering is accomplished by varying the molar ratio of the at least two dianhydride components with respect to one another.

24. The method of claim 23 where the diamine component is selected from the group consisting of 4′-diaminobenzanilide (DABA), 2,2-bis[4-(4aminophenoxy)phenyl]-hexafluoropropane (BDAF) and a combination of DABA and BDAF, and the dianhydride component is selected from the group consisting of 3,3′,4,4′-biphenyltetracarboxylic acid dianhydride (s-BDPA), 4,4′-(hexafluoroisopropylidene)di-phthalicanhydride (6-FDA) and a combination of s-BDPA and 6-FDA.

25. The method of claim 23 where the total diamine and total dianhydride components are present in a ratio of approximately 1:1.

26. The method of claim 23 further comprising a monoamine, a monofunctional anhydride or a combination of the foregoing.

27. The method of claim 23 where the desired property is selected from the group consisting of glass transition temperature, tensile strength, mechanical strength, Young's modulus, thermo-oxidative stability and coefficient of thermal expansion (CTE).

28. The method of claim 23 where the material is a substrate to which the polyimide composition will be applied.

29. The method of claim 23 where the material is a material with which the polyimide composition will be used.

30. The method of claim 19 where said polyimide composition comprises at least two diamine components and at least one dianhydride components, and said engineering is accomplished by varying the molar ratio of the at least two diamine components with respect to one another.

31. The method of claim 30 where the diamine component is selected from the group consisting of DABA, BDAF and a combination of DABA and BDAF and the dianhydride component is selected from the group consisting of s-BDPA, 6-FDA and a combination of s-BDPA and 6-FDA.

32. The method of claim 30 where the total diamine and total dianhydride components are present in a ratio of approximately 1:1.

33. The method of claim 30 further comprising a monoamine, a monofunctional anhydride or a combination of the foregoing.

34. The method of claim 30 where the desired property is selected from the group consisting of glass transition temperature, tensile strength, mechanical strength, Young's modulus, thermo-oxidative stability and coefficient of thermal expansion (CTE).

35. The method of claim 30 where the material is a substrate to which the polyimide composition will be applied.

36. The method of claim 30 where the material is a material with which the polyimide composition will be used.

37. The method of claim 19 where said polyimide composition comprises at least two diamine components and at least two dianhydride components, and said engineering is accomplished by varying the molar ratio of the at least two dianhydride components with respect to one another, by varying the molar ratio of the at least two diamine components with respect to one another or by varying the molar ratio of the at least two dianhydride components with respect to one another and varying the molar ratio of the at least two diamine components with respect to one another.

38. The method of claim 37 where the diamine component is a combination of DABA and BDAF and the dianhydride component is a combination of s-BDPA and 6-FDA.

39. The method of claim 37 where the total diamine and total dianhydride components are present in a ratio of approximately 1:1.

40. The method of claim 37 further comprising a monoamine, a monofunctional anhydride or a combination of the foregoing.

41. The method of claim 37 where the desired property is selected from the group consisting of glass transition temperature, tensile strength, mechanical strength, Young's modulus, thermo-oxidative stability and coefficient of thermal expansion (CTE).

42. The method of claim 37 where the material is a substrate to which the polyimide composition will be applied.

43. The method of claim 37 where the material is a material with which the polyimide composition will be used.

44. The method of claim 19 where the diamine component is selected from the group consisting of DABA, 2,2-bis[4-(4aminophenoxy)phenyl]-hexafluoropropane (BDAF) and a combination of DABA and BDAF, and the dianhydride component is selected from the group consisting of 3,3′,4,4′-biphenyltetracarboxylic acid dianhydride (s-BDPA), 4,4′-(hexafluoroisopropylidene)di-phthalicanhydride (6-FDA) and a combination of s-BDPA and 6-FDA.
